(19) United States
(12) Patent Application Publication
(10) Pub. No.: US 2006/0036481 A1
(43) Pub. Date: Feb. 16, 2006

(54) Electronic voter registration system and method

(76) Inventor: Martin A. White, Saint Louis, MO (US)

Correspondence Address: Joseph E. Zahner, 3646 Dover Place, Saint Louis, MO, 63116, US

(21) Appl. No.: 11/252,346

(22) Filed: Oct. 17, 2005

Related U.S. Application Data
(63) Continuation-in-part of application No. 10/900,263, filed on Jul. 27, 2004.
(60) Provisional application No. 60/710,746, filed on Aug. 24, 2005.

(51) Int. Cl. G07C 13/00

(52) U.S. Cl. 705/12

(57) ABSTRACT

A system and a method for facilitating an election. A database containing voter registration information is downloaded from a central computer to a portable computer that is accessible at a polling station. The database can be searched by a proctor or official at the polling station to determine whether a prospective voter is eligible to vote at the polling station. The name or name and date of birth of the prospective voter is entered into a search field of the portable computer and the database is searched. If and when a matching record is found, additional information is displayed on a second screen and the proctor or official can make a determination whether the prospective voter is eligible to vote at the polling place.

This application claims priority to Provisional Patent Application No. 60/710,746, filed on Aug. 24, 2005, and is a Continuation-in-Part of U.S. patent application Ser. No. 10/900,263, filed Jul. 27, 2004.

### BACKGROUND OF THE INVENTION

1. Field of the Invention

The invention relates to a system and method of delivering and accessing electronic information at a point of service. Specifically, a system and method of delivering and accessing voter role information in an electronic format at a polling station is provided.

2. Description of the Related Art

To ensure the health of a free and democratic society, it is essential that voting be carried out in a fair and efficient manner, and in compliance with state and federal statutes. Individuals who are not registered voters, who have been placed on the inactive voters list, and who no longer reside in the precinct, ward or district of a particular polling station must be identified and either permitted to vote at that polling station, not allowed to vote at that polling station, directed to the proper polling place, or provided other direction on how to proceed. Furthermore, those individuals permitted under the rules to vote at a particular polling station must be properly identified and counted as having voted.

Presently, some individual polling stations have an updated paper copy of township lists, lists of active/inactive (or in suspense) voters, and/or a poll book listing the registered voters for a particular precinct. These lists (poll book) can be greater than a thousand pages for any given large municipality, which can have several hundred individual polling stations. This system is very inefficient and prone to inaccuracies. For example, when a prospective voter enters a polling station, his or her name is checked against the list of registered voters in the poll book for that particular polling station. If the prospective voter is not listed in the poll book, the polling station monitor will contact the election office, which will obtain the name and date of birth date of the prospective voter and determine the appropriate polling station for the prospective voter. Many times, the poll judge cannot timely reach the election office during times of active voting because of busy phone lines, lack of cell phone service in the area and/or a general lack of communication.

This system is inefficient, expensive and prone to error. For example, in some districts, polling stations are furnished with expensive cell phones for use in contacting the election office to obtain voter information, since each polling station does not have direct access to the entire voting roles, laptops with adequate T1 lines, and lack of cell phone service in places like gymnasiums, polling locations and rural areas.

New federal mandates that allow for provisional ballots have created some logistical and potentially legal problems for voters and voting districts. Provisional ballots are generally cast by those voters who are not registered to vote or who show up at the wrong polling place, and in cases in which the poll judge cannot reach the election board because of a lack of communication. A problem with provisional ballots in many jurisdictions is that provisional ballots may not be counted if they are cast in the wrong polling place, which obviously defeats the purpose of the provisional ballot cast because the voter has found himself in the wrong polling place.

### SUMMARY OF THE INVENTION

An object of the invention is a system and method of directly accessing up-to-date and useful information on a portable electronic device (e.g., computer). The system and method greatly improve the efficiency and accuracy of the voting process. Several advantages of the instant invention include (1) the elimination of the need in many cases for provisional ballots or the improper discarding of provisional ballots, (2) shorter lines and quicker moving lines at polling places due to quick elimination of voters who show up at the wrong polling place, (3) a reduction in the call volume generated at polling places and forwarded to the election center on election day, (4) happier voters, who can obtain relevant voting information at any polling place in a particular county/state, (5) happier election judges, who can determine the eligibility of any prospective worker at any polling place in real time, and (6) reduced stress on the statewide voter registration systems because queries are performed on a handheld devices instead of on-line to a central computer.

In a preferred embodiment, the up-to-date and useful information is voter registration and polling place location information. The method comprises the steps of exporting data from a central database voter registration system onto a portable computer located at a polling station, entering a first information into a searchable field displayed on the portable computer, and obtaining additional information associated with the first information, and making a decision regarding the person associated with the name. In a preferred embodiment, the portable computer is located at a polling place/precinct, the first information is a name, and the additional information comprises the status of a prospective voter as registered to vote or not. Preferably, the method additionally comprises compiling an up-to-date and useful information database, which, for example but not exclusively, may be a voter registration database that includes name, date-of-birth, address, ward and precinct (or the equivalent thereof) for each voter in a state or municipality. The decision to allow or to disallow a prospective voter to vote at the polling station is based upon information displayed on the second screen.

Another object of the invention is an electronic information system, which comprises a central database that contains voter information, a central computer that houses the central database, a portable computer, a means for transferring data between the central computer and the portable computer, a software program that enables a user to enter first information into a field and retrieve additional useful information related to the first information. While the database may relate to any and all myriad useful information, in a preferred embodiment, the database is directed to voter registration information, which comprises name, date-of-birth, address, voting location such as precinct and ward (or equivalent thereof), status (e.g., canceled, in suspense/inactive, active) for a prospective voter, and optionally a voter identification number. Alternatively, but not to the exclusion of the previous, the database may comprise a list of inactive voters.

In another object of the invention, the invention is directed to methods and systems for managing and deploying voter registration information at a polling place using a computer and program to organize, convert and/or transfer voter data to multiple portable electronic devices for use at polling places. The system comprises a precursor voter database, a central computer (or a plurality of central computers across a voting district) and converter software, a converted voter database, a portable computer or a plurality of portable computers, and a means for transferring the converted voter database from the central computer to the portable computer(s). The precursor voter database may be a paper file or an electronic database file containing records of prospective voters. The converted voter database is an electronic database of records in a format compatible with the portable computer. The records contain voter registration data such as name of voter, birth date of voter, voter status (preferably active vs. inactive), ward/precinct, and street address. In a preferred embodiment, two converted databases are deployed on the portable computer(s), a voter data database and a street data database.

The method according to this object comprises the steps of (1) optionally producing (e.g., from a paper file) or obtaining a first electronic database file of voter registration information, the information includes the name of a voter, the birth date, the status (preferably active vs. inactive), the ward/precinct, and the street address, (2) converting the first electronic database file into a second electronic database file of a type that is generally exportable across one or more computer systems, the type such as, e.g., comma separated value (“CSV”) or (preferably) tab separated value (“TSV”) format, (3) converting the second electronic database into a third electronic database having a format that is accessible via the portable computer (preferably a palm database (“PDB”) format), and (4) downloading the third electronic database onto the portable computer(s) (preferably Palm OS® personal digital assistant), which. can be distributed to local polling places.

In yet another object of the invention, the invention is directed to a method for collecting, transferring and/or storing voter data. Voter information is obtained from the prospective voter at the polling place by an election official, the data is inputted into a portable computer device, such as for example a Palm PDA device, which may be accompanied by an accessory input device such as a keyboard. The information may be name, address and/or birth date, or whatever information is requested to facilitate the voting process, verify a voter's eligibility, and/or develop an up-to-date voter registration list. The information that now resides on the portable computer may be transferred to a media device such as a multimedia card or other like device. The media or the portable computer is brought to a central election office and the information is transferred to a central computer. The information is then integrated into the voter registration database, in whatever form, that is used by the election office.

### BRIEF DESCRIPTION OF THE DRAWINGS

FIG. 1 depicts an electronic voter registration system.

FIG. 2 depicts a method of conducting an election.

FIG. 3 depicts an exemplary PDA screen shot showing a query field.

FIG. 4 depicts an exemplary PDA screen shot showing an active voter.

FIG. 5 depicts an exemplary PDA screen shot showing an inactive voter.

FIG. 6 depicts an exemplary PDA screen showing a voter not found in the database (i.e., an ineligible voter).

FIG. 7 depicts an electronic voter system with additional desktop computer database format converter.

FIG. 8 depicts a method for conducting an election with the additional steps of converting the voting database of an election district into a downloadable format.

FIG. 9 depicts a screen shot of a desktop software application used to generate a PDA voter and street database from a tab separated database, and a logo (EAlogo.pdb) as a bitmap file.

FIG. 10 depicts an exemplary screen shot showing the results of a sample street search.

FIG. 11 depicts the street search query screen shot, with the added functionality of searching by zip code.

FIG. 12 depicts a flow chart of a particular preferred embodiment of the Election Administrator's Election Assistant system and process.

### DETAILED DESCRIPTION OF THE PREFERRED EMBODIMENTS

The inventor has developed a system and method for enabling the access of information contained in a large database on a portable computer useable at a remote site. The inventor envisions that the system is applicable to any business method wherein useful information housed on a central computer may be downloaded onto a portable computer for use at a site distant from the central computer. Thus, the invention is not to be construed to be limited solely to the embodiment herein disclosed, but by the claims which follow.

The inventor has recognized the need for reliable and readily accessible information at polling stations. Currently, voter registration information is printed, bound (this is a poll list) and distributed by an election office to individual polling stations. The information is then used by a polling station proctor or official to determine if a prospective voter, who enters a polling station, is eligible to vote. If the prospective voter is not on the roster for a particular polling station and is not on the inactive voter list, the polling station official can contact the election office to determine which polling station the prospective voter should report to vote. The prospective voter, who's name is not found on the poll list or inactive voter list, may be allowed to cast a provisional ballot with the caveat that in some jurisdictions, the provisional voter must cast that provisional ballot in the correct precinct. Thus, the inventor has invented a system and a method for efficiently delivering accurate and up-to-date voter registration information to each polling station in a voting area.

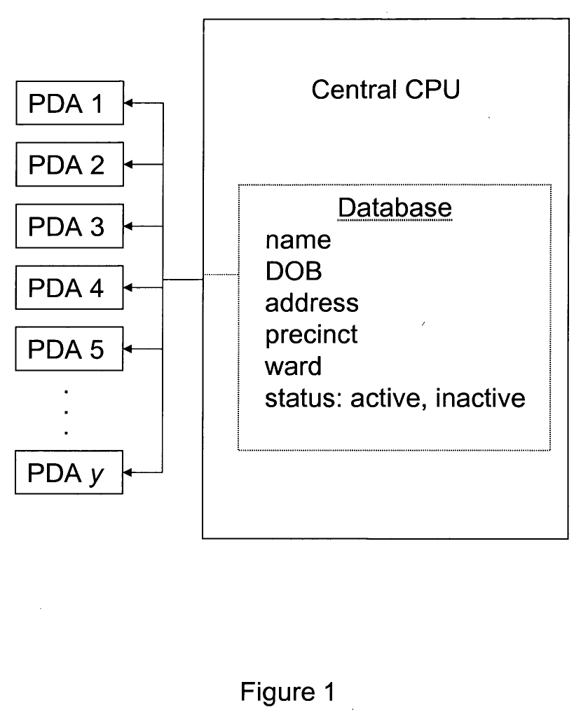

In one embodiment, the invention is directed to an electronic voter registration system. In a particular preferred aspect of the embodiment (FIG. 1), the electronic voter registration system comprises a database of voter information in electronic format. The database contains records for registered voters of a particular voting area (municipality, county, state, and the like), wherein each record includes the name, date of birth and address of a voter. More preferably, each record also includes the precinct, ward and voting eligibility status of the voter. Status refers to whether the voter is active or inactive, in suspense, canceled, military, and the like. Alternatively, but not exclusively, status can refer to whether a voter has already cast a ballot in the current election, and is therefore ineligible to vote again. Database structures are well known in the computer arts and are readily available as shareware, freeware and from commercial vendors such as FileMaker, Gupta, iAnywhere, InterSystems, IBM, Microsoft, Oracle, Pervasive Software, Progress Software, Sybase, and TimesTen. Some common voter registration systems include ES&S (offered by Election Systems and Software, Inc.), VR Systems, HART Interactive and IBM.

Preferably, the database, which is maintained and up-to-date, resides on a central computer, which may be a server, personal computer, or the like, and which may be located in a state controlled office, an election office, space controlled by an election office, or with a vendor, or any combination thereof. Prior to an election, all or part of the database is transferred to one or more portable computers, which are located and used at one or more polling stations. Portable computers include, but are not limited to pocket PC (windows, linux, mac os), cell phone, tablet PC, Palm OS device, and laptop computer. In a preferred embodiment, the portable computer is a personal digital assistant (“PDA”). More preferably, the portable computer is a Palm OS device.

The database is transferred from the central computer to the portable computer by any one or more methods that are well known in the art, including, but not limited to, wire transfer means, such as through a USB connection, serial connection, modem or network (e.g., hot synchronization), or wireless means, such as by infrared (“IR”), microwave and radiowave, and/or by physical transfer of media, such as CD, multimedia or memory card, Zip™ disc, and the like. Examples of wireless transmission methods or protocols include Bluetooth (2.56 GHz band), IrDA (infrared frequencies), and Home RF or SWAP (2.45 GHz range). In a preferred embodiment, the transfer is by hot synchronization of the central computer and a PDA. In a more preferred embodiment, the transfer is by transfer of a multimedia or memory card between the central computer and PDA.

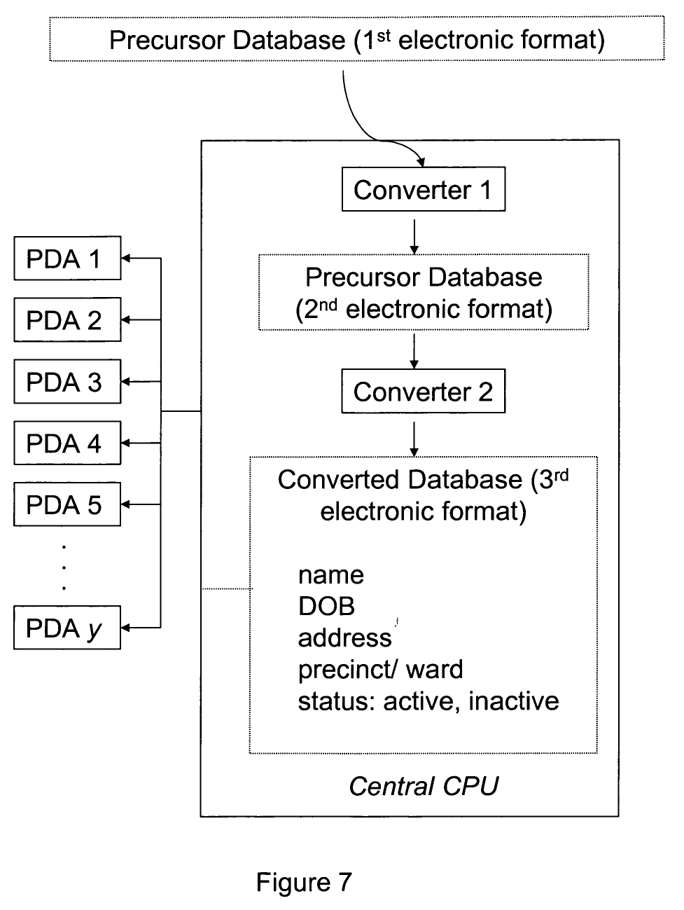

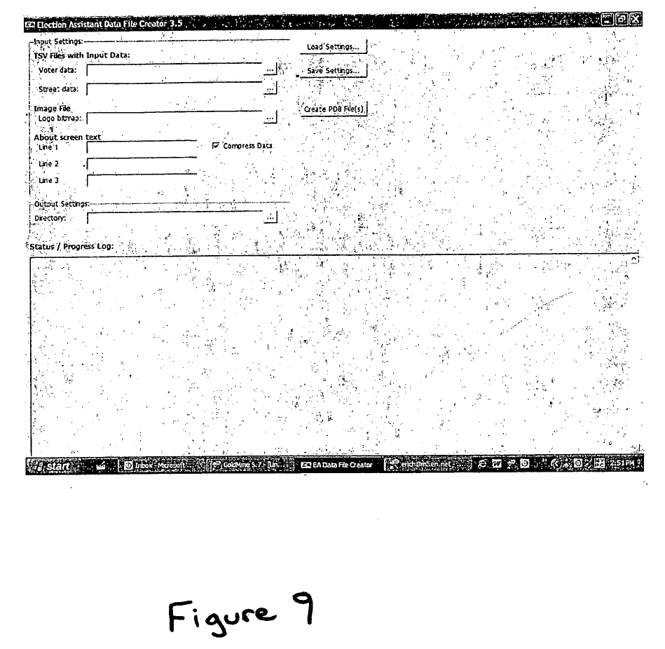

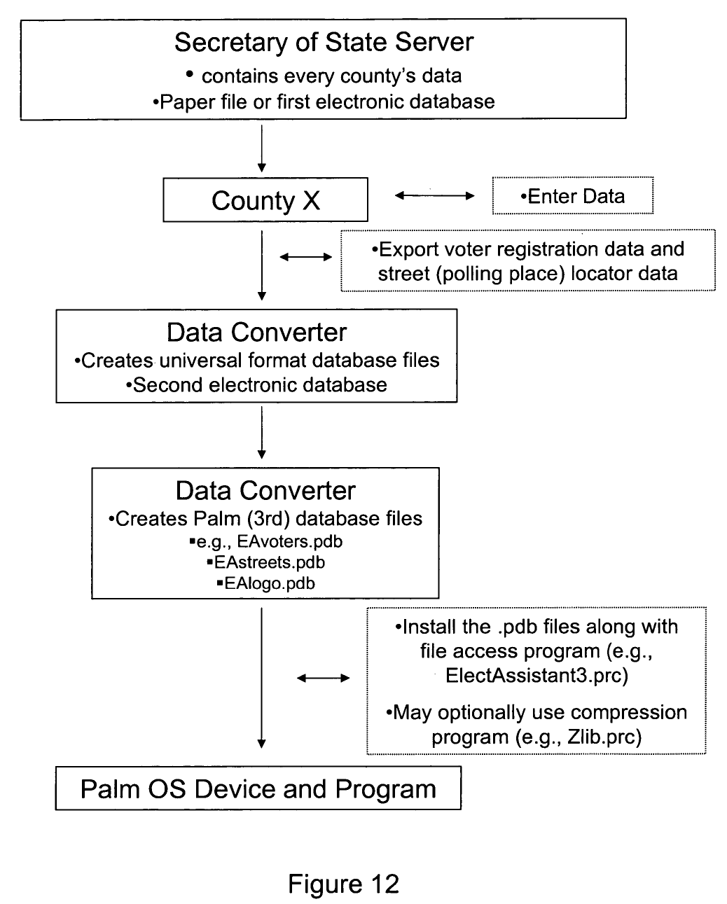

In another preferred aspect of this embodiment, (FIG. 7 and alternatively FIG. 12), the electronic voter registration system (supra) comprises a database of voter information in a first electronic format, which may be in any one or more myriad database formats, including for example text file, spread sheet file, access file and/or the like. The database in this first electronic format is then converted to a universal format (second electronic format) using a converter software located on the central computer or a multiplicity of computers. Universal formats are generally recognized in the art, and include for example tab separated/tab delimited (“tsv”, aka “txt”), comma separated (“csv”), and xml. The second electronic format is then converted, using a conversion software program, to a format that is compatible for a portable computer (third electronic format). In a preferred embodiment, the portable computer is a Palm OS PDA and the third electronic format is a palm database format (“pdb”). FIG. 9 depicts a screen shot of a window of a conversion program that converts the second electronic format database (in this case, a tsv format) into a pdb format database, prior to loading the database onto the PDAs.

FIG. 12 depicts in some level of detail a more preferred embodiment of the instant system. Voter registration data, which is likely to be some form of text file, from the state is converted by a program into a universal format. The converted data is then put through a desktop application program (the second data converter of FIG. 12) that converts the data into a Palm OS format—i.e, the output is EAlogo.pdb for the logo, EAvoters.pdb for voter registration data, and EAstreet.pdb for street locator information (the EA prefix stands for Election Assistant)—which is exported to a memory card and loaded onto a PDA. A software program runs on the PDA to enable the election worker to access the database files. In a preferred aspect the program is a Palm OS program. More preferred, the program is named ElectionAssistant.prc.

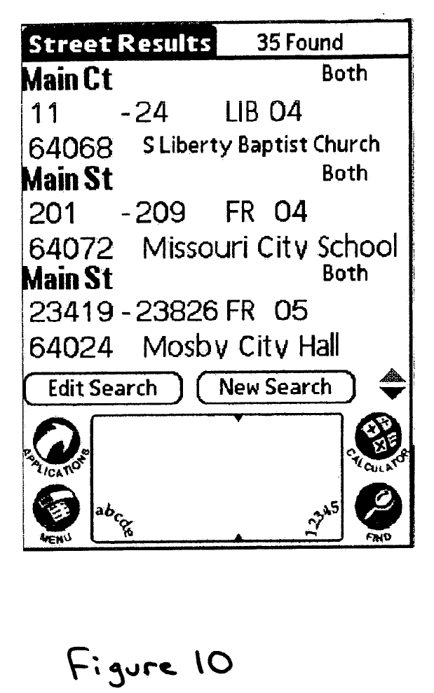

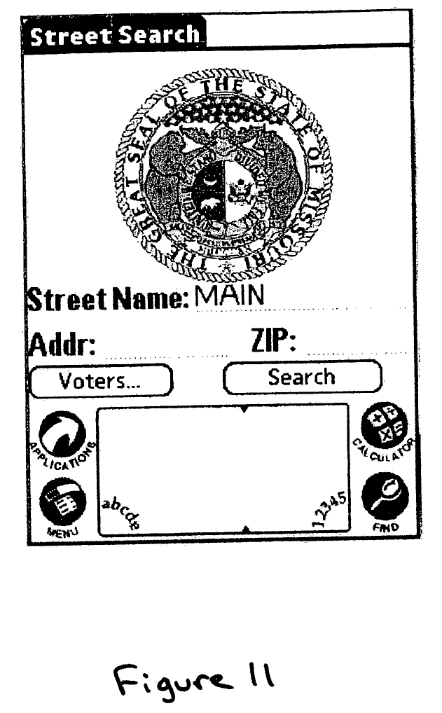

In a preferred aspect, two databases are loaded onto the PDAs, (1) a voter dataset (see table 1), and (2) a street dataset (see table 2 and FIGS. 10 and 11). In a more preferred aspect and in addition to downloading a voter dataset and a street dataset onto the portable computers, a voting district or state logo can be downloaded onto the portable computers, as shown in FIG. 11. Additionally, an “about” screen data can be downloaded onto the portable computers, to identify the vendor, district, date of election, and/or other information.

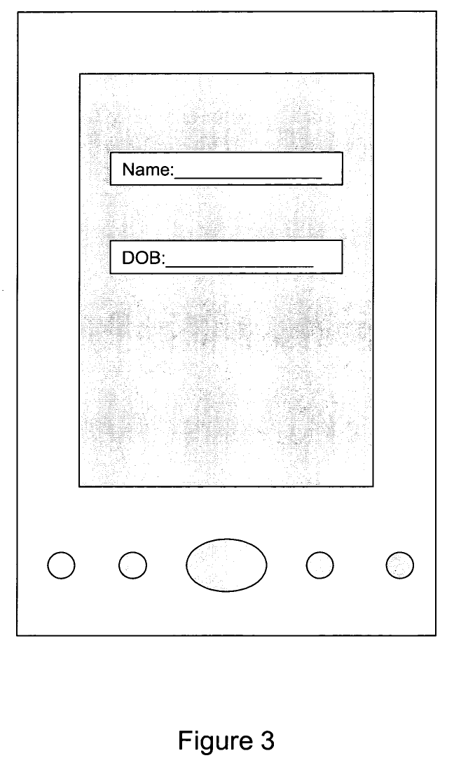

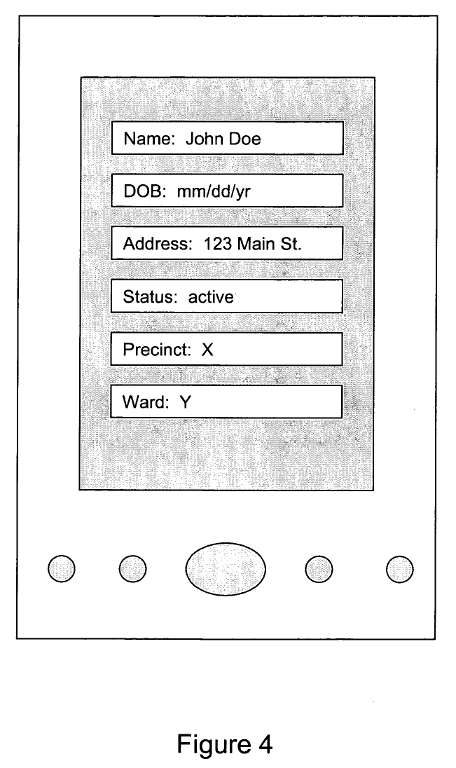

In this embodiment of the system, multiple portable computers contain the database and are distributed to multiple polling stations throughout an official voting area. Displayed on the screen of the portable computer (“first screen”) is a searchable field, into which a polling station official or other individual can input the name of a prospective voter (FIG. 3). The input can be by way of any input device, such as for example a stylus, a keyboard, an optical electronic card, a mouse, and a microphone. Preferably, the name is input using a keyboard or a stylus. The input name is compared to the records of the database and a matching record is called up and useful fields are displayed on the screen of the portable computer (“second screen”) (FIGS. 4, 5 and 6). The polling official or other individual can make a decision to allow or disallow the prospective voter associated with the input name to vote. More preferably, the first screen can display an additional searchable field, such as date-of-birth, to assist in narrowing the database search. Alternatively, the arrow keys on the PDA may be toggled to scroll through the list of names in the database.

TABLE 1
Voter Search File

| Field | Description | Size/Value |
|---|---|---|
| 1 | Last name of voter | Up to 20 characters |
| 2 | First name of voter | Up to 20 characters |
| 3 | Birth Date in YYYY-MM-DD format | |
| 4 | Active/Inactive | Should be a single letter A or |
| | | I |
| 5 | Ward/Precinct - this is displayed as-is in the | Should be lkess than ˜12 |
| | software, so you can put, for example “Wr 3 Pc 12” | characters, to fit on a Palm |
| | if you want that appearance in the result; or you | screen. Exact width |
| | can put just a number, or the name of the precinct, | depends on which |
| | precinct part, ballot style, voter ID number, etc . . . | characters (i.e., “w” is wider |
| | | than “i”). |
| 6 | Street address of the voter | |
| 7 | Extra data field - you can put any value here, such | About 25 characters will fit |
| | as a polling place address, voter ID, etc . . . | on the Plam screen. |

TABLE 2
Street Search File

| Field | Description | Size/Value Limitations |
|---|---|---|
| 1 | Street Name | Up to 30 characters |
| 2 | Direction indicator (N etc.), this is simply | Up to 4 characters |
| | appended to the street name in the software | |
| 3 | Low end of the street number range for this | Up to 7 characters 0-9999999 |
| | record. Must be | |
| 4 | High end of the street number range for this | Up to 7 characters 0-9999999 |
| | record. | |
| 5 | Parity: indicate which numbers in the above range | EVEN, ODD, or BOTH |
| | this record applied to. | |
| 6 | Ward/Precint - this is displayed as-is in the | Should be less than ˜12 characters, |
| | software, so you can put, for example “Wr 3 Pc | to fit on Palm screen. Exact width |
| | 12” if you want that appearance in the result; or | depends on which characters (i.e. |
| | you can put just a number, or the name of a | “w” is wider than “i”) |
| | precint, etc. | |
| 7 | Zip Code | 5 characters |
| 8 | Extra Data Field - you can put any value here, | About 25 characters will fit on the |
| | such as a polling place address. | Palm screen. |

In another embodiment, the invention is directed to a method of facilitating an election. The method enables an official or proctor at a polling station to access information about a prospective voter on an easy to use portable computer, and to provide useful advice to the prospective voter. The method comprises creating, importing or updating a database, which contains voter records, on a central computer. The database is downloaded onto one of more portable computers using a wire, wireless or direct transfer method, wherein the database is stored on a medium that can be moved from the central computer and loaded onto the portable computer (e.g., disc, CD, chip). The central computer can be a server or personal computer that operates using any operating system, such as Palm, Windows, Linux, Mac and the like. Likewise, the portable computer may utilize any operating system, such as Palm, Windows, Linux, Mac and the like. In a preferred embodiment, the central computer utilizes a windows operating system and the portable computer is a personal digital assistant (“PDA”) which utilizes a Palm operating system, and the database is transferred using a hot synchronization method through a USB, serial, modem or network connection. In a more preferred embodiment, the database is transferred on a memory or multimedia card that is transferred between the central computer and the PDA.

Having the database loaded onto the portable computer, the portable computer is accessed at a polling station. A prospective voter enters a polling station and optionally (i.e., in some jurisdictions) presents a proctor or official with a form of identification. The proctor or official enters the name or name and date of birth of the prospective voter into a searchable field displayed on the screen (“first screen”) of the portable computer, which then executes a search program to search the records of the database. If the name or name and date of birth is matched to a record of the database, additional fields associated with that record are displayed on the screen (“second screen”) of the portable computer. Those additional fields include one or more of address, precinct, precinct part, ward and status of the prospective voter. Status may be active, inactive, in suspense, canceled, ineligible, or not available. Preferably status is either active or inactive. If the name or name and date of birth of the prospective voter does not match with any record in the database, additional fields may not be displayed on the second screen, but rather a notification is displayed on the second screen indicating that no match was found in the database.

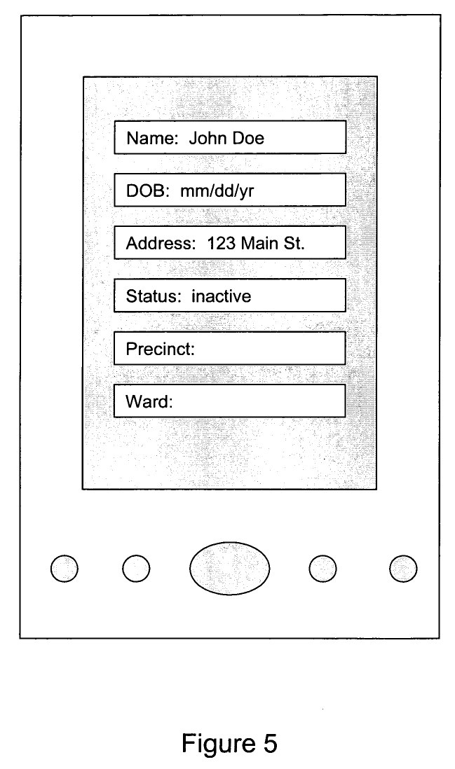

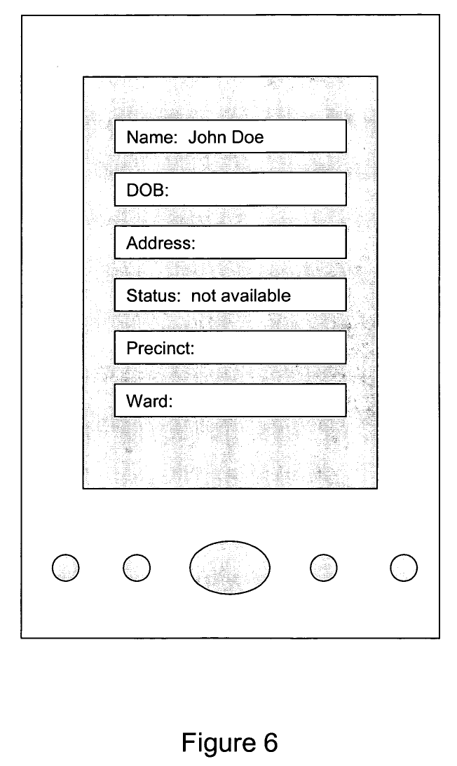

Having obtained additional information related to the prospective voter, the proctor or official at the polling station makes a decision whether to allow or disallow the prospective voter to vote at the polling place. If the prospective voter has a status of active or inactive/in suspense and the precinct and ward match with the polling place, the voter may be allowed to proceed to vote (FIGS. 4, 5). If the prospective voter has a status of active or inactive/in suspense and the precinct and ward do not match with the polling place, the proctor or official may notify the prospective voter of the proper polling place that serves the precinct and ward of the voter. If no record match has been found related to the name or name and date of birth, the voter may not be allowed to proceed to vote (FIG. 6), or the voter may be allowed to file a provisional ballot.

In yet another embodiment, the invention is directed to an electronic voter system as described above, wherein the database comprises the records of inactive voters. The database resides on a central computer and is downloadable to a portable computer.

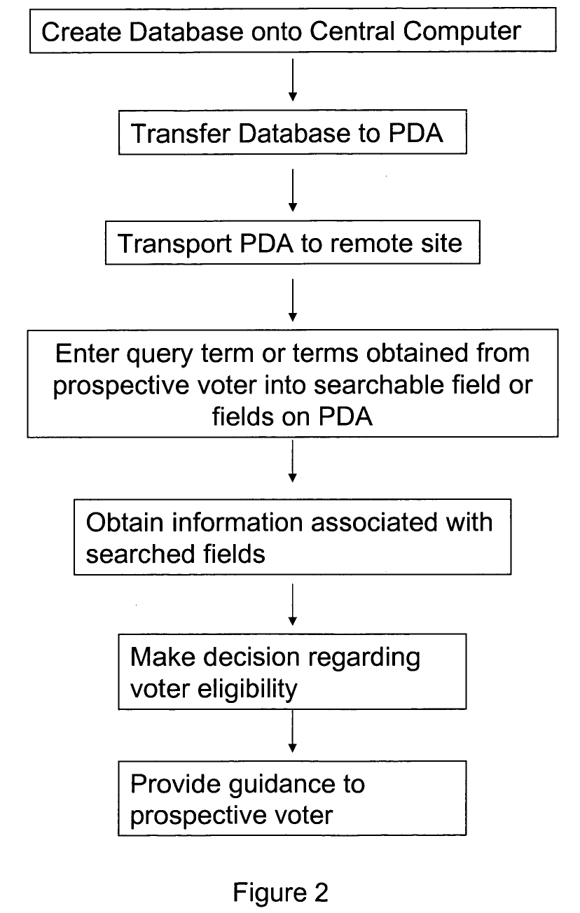

In yet another embodiment, the invention is directed to a method of facilitating an election, comprising updating a database comprising an inactive voter list, downloading the database to one or more portable computers, entering the name or name and date of birth into a searchable field on the first screen of the portable computer, whereby the name or name and date of birth are searched against the database (FIG. 2). If and when the name or name and date of birth are associated with a record in the database which comprises the inactive voter list, a record is displayed on the second screen of the portable computer, indicating that the prospective voter is inactive. In another aspect, street information and/or name and/or zip code information may be given to the voting official by the prospective voter. The official inputs that information into the voter search screen and/or street search screen of the portable computer and sends the query. If the voter is active or inactive for that polling place, the voter is allowed to vote. If the voter is in the wrong polling place, the official can obtain the correct information and send the voter to the correct polling place. If the voter is not registered to vote, the street information can be entered into the street search mode of the portable computer, which would return the precinct and polling place that the non-registered voter may go to file a provisional ballot.

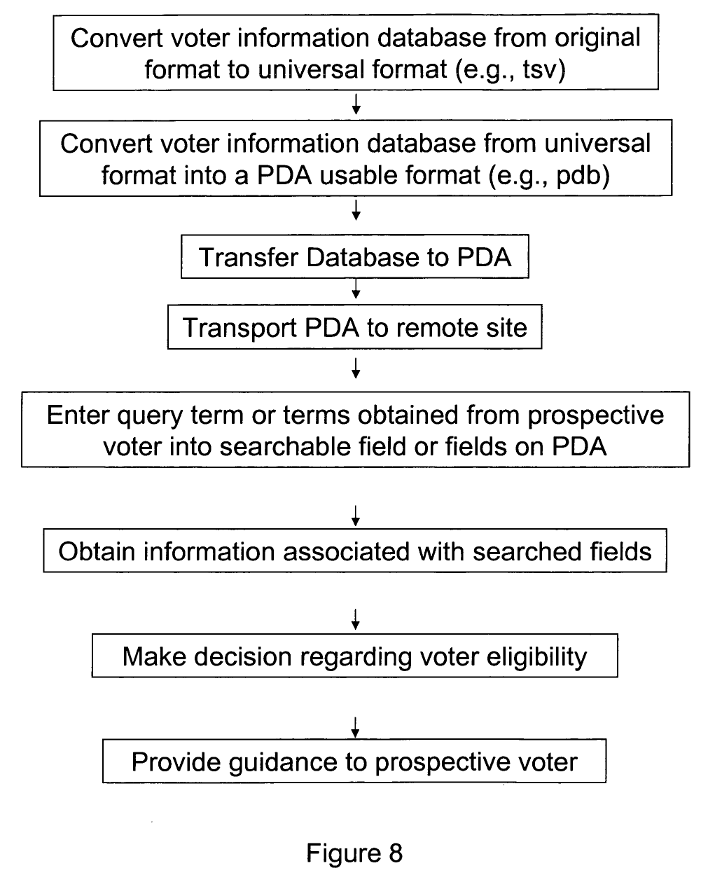

In another aspect of this embodiment (supra), a voter information database is converted into a format useful for the portable computers (FIG. 8). If the voting information is in a paper format, it can be converted into a text format via hand-entering the data into an electronic text file, or scanning and converting the data to an electronic text file using a character recognition program, to produce the first electronic format of the database. This database is then subjected to a conversion software program that converts the text (or other, e.g. pdf) into a universal database format to produce the second electronic format database. Universal database formats are generally known in the art (e.g., xml, tsv [aka txt], csv), as are conversion software packages and methods of developing conversion programs. At any point, extraneous information (i.e., fields) may be eliminated from the database. The second electronic database is then converted into a form that is useable on the portable computer. Preferably, the tsv database is converted into a palm readable format (pdb). FIG. 9 depicts a screen shot of the tsv to pdb converter, in which two files, the voter data file and the street data file, are converted prior to downloading onto a Palm PDA. Optionally, an official logo representative of a particular voting area, province or state is downloaded from a central computer onto the portable computers (e.g., image file box of FIG. 9 and see FIG. 11.) Once the database is loaded onto the portable computer, the portable computer is dispatched to a polling place, where it is used to assist the voting process by providing voter status (supra) to a prospective voter.

Preferred embodiments of the invention are described above. Other embodiments within the scope of the claims herein will be apparent to one skilled in the art from consideration of the specification or practice of the invention as disclosed herein. It is intended that the specification be considered exemplary only, with the scope and spirit of the invention being indicated by the claims which follow below.

What is claimed is:

1. A system for voting comprising a first voter registration database, a first data converter to convert the first voter registration database to a second voter registration database, a second data converter located on the central computer to convert the second voter registration database to a third voter registration database, and a portable digital assistant.

2. The system of claim 1 wherein the first voter registration database is a paper text file or an electronic text file comprising the names of registered voters, the status of registered voters, the street address of registered voters, and the place of voting for registered voters.

3. The system of claim 2 wherein the status of registered voters comprise one or more of active, inactive, in suspense, cancelled and military.

4. The system of claim 1 wherein the second voter registration database is an electronic database (a) having a universal format selected from the group consisting of tab delimited (“tsv”), comma separated (“csv”), and xml, and (b) comprising the names of registered voters, the street address of registered voters, the place of voting for registered voters, and the status of registered voters, wherein status comprises one or more of active, inactive, in suspense, cancelled and military.

5. The system of claim 1 wherein (a) the third voter registration database is an electronic database having a Palm operating system format (PDB) and comprising a street searchable subdatabase, a voter registration subdatabase, and a bitmap image file of a logo representing a particular voting jurisdication, (b) the central computer is a desktop computer located at an election office, and (c) the personal digital assistant is a Palm OS® device.
